(19) United States
(12) Patent Application Publication
(10) Pub. No.: US 2004/0015490 A1
(43) Pub. Date: Jan. 22, 2004

(54) Searching station accessed by selection terminals

(75) Inventors: John Snyder, Cambridge (GB); Martin Porter, Cambridge (GB)

Correspondence Address: FRISHAUF, HOLTZ, GOODMAN & CHICK, PC, 767 THIRD AVENUE, 25TH FLOOR, NEW YORK, NY, 10017-2023, US

(73) Assignee: Applied Psychology Research., Ltd., London (GB)

(21) Appl. No.: 10/203,862

(22) PCT Filed: Feb. 8, 2001
(86) PCT No.: PCT/GB01/00480

(30) Foreign Application Priority Data
Feb. 15, 2000 (GB) 0003411.6

(51) Int. Cl. G06F 17/30

(52) U.S. Cl. 707/3

(57) ABSTRACT

Selection terminals, typically PC computers running internet browsers, make search requests to a searching station or search engine. The searching station receives search terms and performs a probabilistic searching operation. In this way, emphasis is placed upon received terms that occur infrequently within source material. Search results, in the form of web sites of interest of which the high value search terms occur are returned back to the selecting terminal for display. An icon is displayed at the selection terminals and search terms are supplied to the searching station by high-lighting text of interest and then dragging and dropping it to the icon. In this way, it is possible for sophisticated searching operations to be performed with significantly less effort required on the part of the user. In particular, there is no requirement for a user to specify Boolean operations.

### BACKGROUND OF THE INVENTION

1. Field of the Invention

The present invention relates to a method of accessing data over a network wherein a search is performed on a database of data items accessible over the network in order to identify relevant data for a user.

2. Description of the Related Art

Considerable advances have been made in recent years in the provision of computerised systems for identifying particular data items of interest that are often referred to as “search engines”. In particular, search engines are known that have the purpose of indexing documents available on the world wide web. These documents are thereby made easily available to users who have a computer terminal equipped with a web browser. In order to signify characteristics of documents to retrieve, a user is invited to type words into a query box. The search engine uses these words to identify documents on the web that are likely to be of interest.

Statistics have shown that, while search engines are widely used, they are mostly used inefficiently. On average, the number of words supplied by a user to define a query is only one or two. From this number of words very little information about the user's interests can be known. As a result, many search engines operate using what is known as a Boolean search. In its simplest form, a single word defines the user query. This word is then used to index, via standard hashing or tree search algorithms, all documents known to contain that single word. The list is prioritised by the frequency of occurrence of the single word within each document. The documents containing the highest frequency are identified and supplied back to the user, in the form of a list of documents arranged in descending order of word frequency.

When two or more words are specified as a query in a Boolean search, the way they are treated depends on the syntax of the search engine. For example, in the popular AltaVista (RTM) search engine, simply typing in two words identifies the set of documents containing either or both words. The word frequencies are summed, so that documents containing both words will appear at the top of the results list. Most search engines provide more sophisticated Boolean search commands. For example, AltaVista interprets a “+” character before a word as an instruction that all identified documents must contain that word. A “−” character indicates that any document containing that word shall be excluded from the identified set of documents.

These simple techniques enable users to generate more sophisticated Boolean search commands, possibly containing many words. However, most users do not use these capabilities. Simply typing in a large number of words results in an extremely large number of documents being identified, typically in the order of several million, within which only a small percentage contain information likely to be of interest. It would be hoped that these will appear at the top of the results list. However, the random nature of this approach does not provide any assurance that truly relevant documents will be found easily. For this reason most users simply type in one or two words that they hope will be effective.

Given that one or two words are all that are usually provided in a query, there is no motivation for the designers of search engines to enhance the sophistication with which a search is performed; the information that a user is accustomed to providing is simply too brief to make a sophisticated approach worthwhile.

### BRIEF SUMMARY OF THE INVENTION

According to an aspect of the present invention, there is provided searching apparatus having a searching station and a plurality of selection terminals. The searching station comprises search request receiving means configured to receive search requests from the selection terminals in the form of a plurality of search terms. Probabilistic searching means are configured to identify terms of high value that occur infrequently in machine readable documents. Output generating means is configured to supply search results data to a requesting selection terminal. Each of the selection terminals comprises search specifying means, text display means, text selection means configured to respond to manual input commands so as to convey a portion of selected text to such search specifying means, output means configured to receive search specifying data from the search specifying means and to transmit a search request to said searching station, and input means configured to receive search results from the searching station and to supply said search result to said text display means.

In a preferred embodiment, the probabilistic searching means analyses user selected text to identify query terms.

According to a second aspect of the present invention, there is provided a method of searching at a searching station. The method comprises the steps of receiving search requests from one of a plurality of selection terminals defined by a plurality of words copied from text displayed at the requesting selection terminal. A probabilistic search is performed using high value terms derived from the received words, in which high value terms occur infrequently within source material referenced by an indexed database. Furthermore, the search results are supplied to the requesting selection terminal.

Preferably, the probabilistic search calculates the weighting value for each document referenced in the database by combining significance values of each query term that indexes that document.

According to a third aspect of the present invention, there is provided a method of instructing a probabilistic searching station to perform a search on locations of interest in which high value index terms are stored in a database, being terms that occur infrequently in source material locatable over the internet. Method comprise of the steps of instantiating a search tool icon having the location of said searching station embedded therein and configured to convey search terms to said location. The method displays textural matter and allows a region of displayed matter to be identified as being of interest. A representation of the matter of interest is conveyed to the displayed icon in response to manual operation and data received from the searching station is then displayed.

### BRIEF DESCRIPTION OF THE SEVERAL VIEWS OF THE DRAWINGS

FIG. 1 shows the Internet with connections to Internet Service Providers, Intranets, a user terminal and a search engine;

FIG. 2 details user actions at the user terminal shown in FIG. 1 while accessing the search engine also shown in FIG. 1;

FIG. 3 summarises interaction between the user terminal and search engine shown in FIG. 1, in accordance with the present invention, and details the user terminal as comprising a computer, a monitor, a mouse and a keyboard;

FIG. 4 summarises components of the computer shown in FIG. 3, including a memory;

FIG. 5 details contents of the memory shown in FIG. 4, including a search application;

FIG. 6 details the steps performed by the search application shown in FIG. 5;

FIG. 7 details the search engine shown in FIG. 1, including a computer and a search engine database;

FIG. 8 details the computer shown in FIG. 7, including a memory;

FIG. 9 details contents of the memory shown in FIG. 8, including an indexer application and a search application;

FIGS. 10 and 11 detail steps performed by the indexer application shown in FIG. 9, including a step of applying a stemming algorithm and a step of updating postings;

FIGS. 12 and 13 illustrate the effects of the stemming algorithm used in FIG. 10;

FIG. 14 illustrates the use of the stemming algorithm used in FIG. 10;

FIG. 15 illustrates the postings that are updated in FIG. 10;

FIG. 16 illustrates additional data that is used to update the database shown in FIG. 7;

FIGS. 17 and 18 detail equations used by the search engine shown in FIG. 7;

FIG. 19 details steps performed by the search application shown in FIG. 9, including a step of calculating a document weight and a step of transmitting a list of documents;

FIGS. 20 and 21 detail equations that may be used in the calculation step shown in FIG. 19; and

FIG. 22 illustrates the results displayed on the user's monitor in response to the step of transmitting a list of documents shown in FIG. 19;

FIG. 23 details the search icon identified in FIG. 3; and

FIG. 24 illustrates right hand and left hand extensions of the icons shown in the FIG. 23.

### BEST MODE FOR CARRYING OUT THE INVENTION

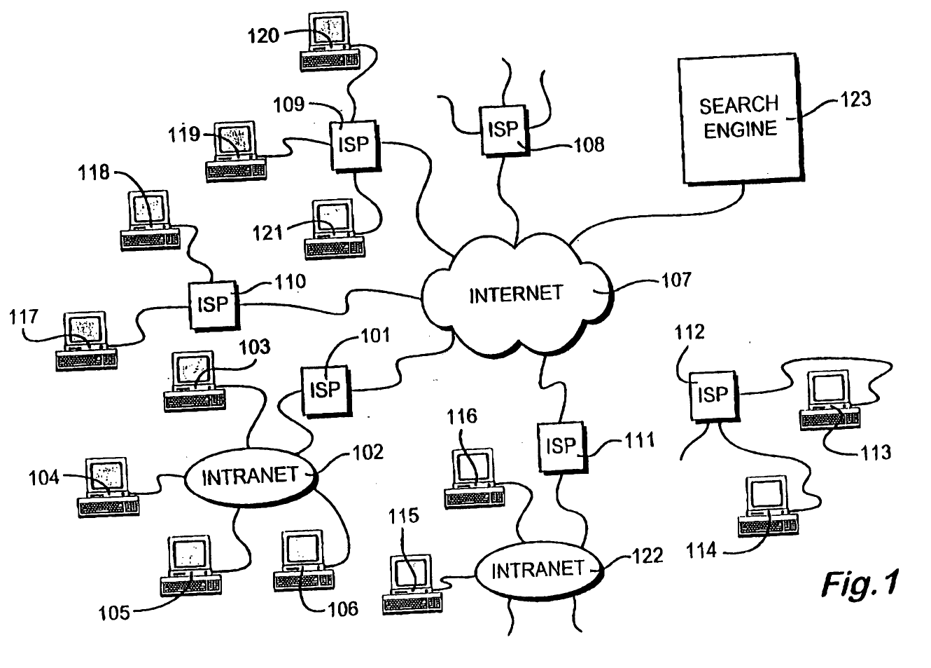

The Internet is illustrated in FIG. 1. A corporate Internet Service Provider (ISP) facilitates Internet connectivity to a company intranet 102, which connects several desktop computers 106. The intranet provides file sharing and serving capabilities between the companies employees operating the computer terminals 103 to 106. Useful data may also be obtained from other computers connected via the Internet 107. Several Internet service providers 108 to 112 provide connectivity to other computer users located at terminals 113 to 121, including those connected via another intranet 122. Furthermore, these Internet service providers host web pages that may be accessible generally to any computer user on the Internet 107. On the Internet as a whole, the number of web pages is many hundreds of millions. While many of these may be uninformative, or contain only trivial data, increasingly it is accepted that the world wide web, comprising these pages, contains a significant amount of useful information.

A problem exists in that sorting useful and non-useful information on the basis of search criteria supplied by a user to a search engine 123 may be extremely difficult. This problem is particularly severe, because most Internet users provide only one or two words as a query to a search engine 123 as to which documents are of interest. Thus, although the Internet is by nature increasingly rich in freely available information, this information is mixed in value. Also, while the amount of valuable information continuously increases, so does the amount of non-valuable information. The problem of deciding which is which depends, in part, upon the information supplied to the search engine 123 from a computer terminal 105 by a user who has some idea in their mind as to what type of information he or she is interested in.

The process of information retrieval comprises several stages, each of which is prone to error and ambiguity. In the first stage, there exists an idea, in the mind of a user sitting at a computer, as to what kind of information they are interested in. This idea must be translated into a query for a search engine. This translation step, performed by the user in their mind, is a major source of error and ambiguity. Most users simplify the task of translation by simply thinking of one or two words that best express their interest.

In a second stage of information retrieval, the query must be interpreted by a search engine in such a way as to identify, from all documents that it knows about, those documents that are most relevant to the user. The efficiency of this stage in information retrieval is also affected by the kind of information the database uses to represent a document's contents. If a Boolean search method is used, the database need only know which words occur, and with what frequency. During a Boolean search, no account is taken of the linguistic character of words. If many words are supplied as a query, the concepts that they define, their rarity, their possible significance, is ignored.

The efficiency of the information retrieval process as a whole is determined by a concatenation of the errors and ambiguities introduced during the process of the user formulating a query, and the subsequent process of analysing that query to identify documents. The efficiency of the process as a whole is measured not by the relation between the query and the documents that are identified, but by the relation between the idea that the user had in his or her mind while formulating the query, and the list of documents that is generated as a result. When viewed in this way, many information retrieval systems are extremely inefficient.

In certain situations, information about a user's interest is available in great detail, in computer-readable form, without the user having to make any effort to express their interest formally. An example of such a situation is the reception of an email. An email is displayed on a users terminal 105 at the user's request. As the user reads the email, the user is likely to obtain information of value, and formulate ideas and queries mentally, as a natural result of the reading process. At this precise time, a user's interests are related closely to the specific set of concepts and ideas identified by the words and language in the email. The ideas in a user's mind, that would ordinarily need to be translated into a query, are already present in the computer, and in a highly sophisticated form.

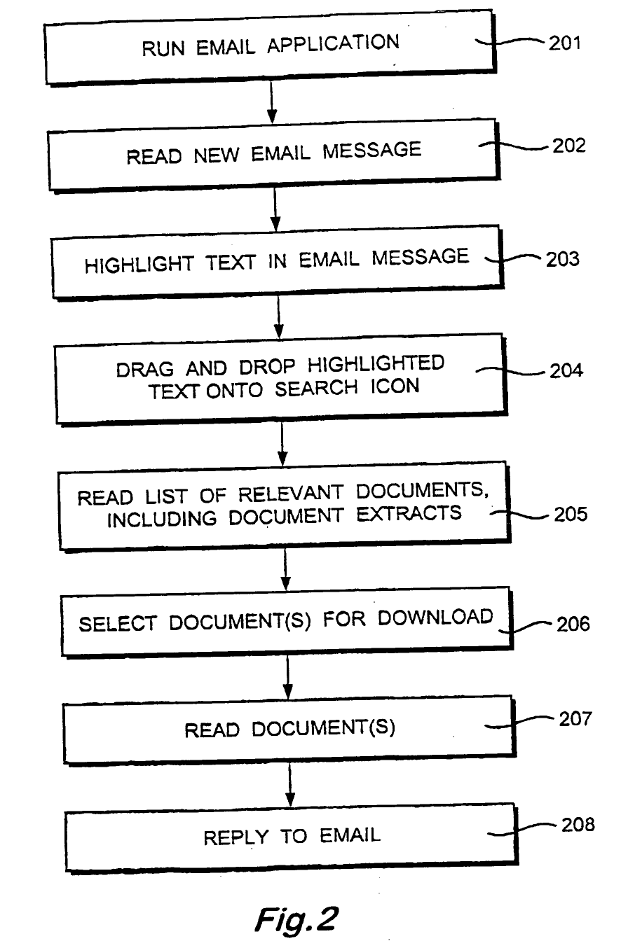

FIG. 2 details operations performed by the user, when using the present invention. The user obtains documents likely to be of relevance, without having to perform the first stage of the information retrieval process, in which ideas in the user's mind have to be translated by the user into a query.

At step 201 the user runs the email application. At step 202, the user reads a new, incoming, email message. Alternatively the user may review a previously received message. At step 203 the user identifies an area of text in the email that is of particular interest. This text may be several hundred characters long. At step 204 the user drags and drops the selected text, using a mouse, onto a search icon in the corner of the terminal's display area. At step 205, the user reads a list of documents likely to be relevant, that has been generated as a result of the search process initiated by the user's action at step 204. At step 206 a document is selected from the list of results for download. This document is considered by the user to be of considerable relevance. At step 207 the user reads the document, and formulates ideas above and beyond those hinted at in the email at step 202. At step 208 the user composes and transmits a reply to the email received at step 202.

The steps shown at FIG. 2 identify a sequence of operations that result in very a large query being transmitted to the search engine 123. The query comprises many words. The meaning of the query is dependent upon the subtlety and richness of the language in which the email is written. In this respect, a major source of error and ambiguity in the information retrieval process has been bypassed.

However, if a long query such as the one generated from an email in this way was to be interpreted as a Boolean search string, the resulting list of identified documents would be enormous. Relevant documents would be scattered throughout the set of identified documents, though with a probable bias towards the top of the prioritised list based on word frequency. The sparsity of relevant documents within the identified set would ensure that the user would have been better off formulating a traditional one or two word query and supplying that to the search engine instead.

In order to take advantage of the method described in FIG. 2, a more advanced form of data access is used, as a replacement for a straightforward Boolean search. In order to take advantage of the meaning inherent in the user-selected text of the email, the search for documents must take account of information inherent in the language that is used to write the email. Thus, by taking into account the words in the context of their language, or the context of their common use, it is possible to obtain considerable additional information from a query comprising many words. This represents an improvement to the second stage of information retrieval: interpreting the query to identify documents.

In combination, these improvements to the first and second stages of information retrieval result in an information retrieval system with the potential to identify documents with a significantly higher probability of being relevant to the query formulated in the user's mind at the moment a search is initiated. Furthermore, the effort required to formulate a query is avoided altogether, making the system far quicker and more reliable to use.

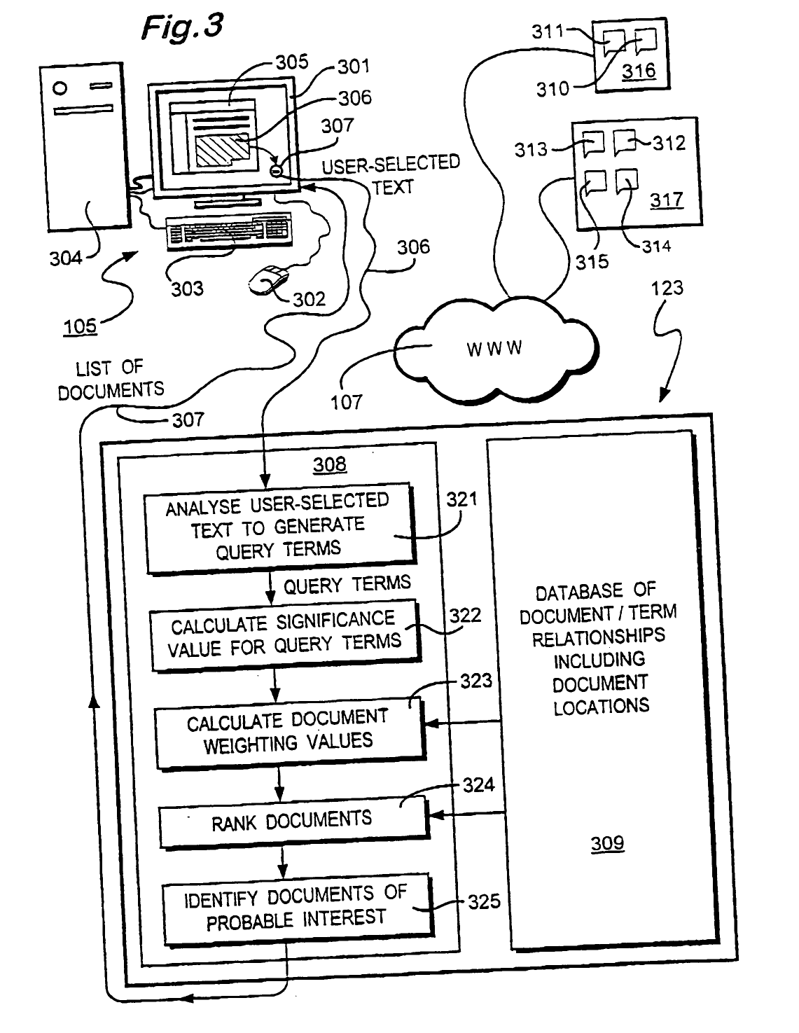

The invention is summarised in FIG. 3. The user's terminal 105 comprises a monitor 301, a mouse 302, a keyboard 303 and a computer 304. The monitor 301 is shown running an email application 305, including an area of user-selected text 306 that has been selected by dragging the mouse 302 in the accustomed manner for graphical user interfaces. As an alternative, various actions may be performed using the keyboard 303, or other input device, resulting in the selection of text as shown. The user-selected text 306 is dragged and dropped, again using the mouse 302, onto a search icon 307. This action triggers an instruction sequence within the computer 304 so that the user-selected text 306 is transmitted via the Internet to the search engine 123. The search engine 123 includes a Probabilistic Information Retrieval System 308. This type of information retrieval system employs measures of word frequency, and other data, in natural language usage. This extra information is used to ensure that an increase in the number of words in the user-selected text 306 improves rather than deteriorates the overall information retrieval process. Identified documents are then supplied as a list 307 that is transmitted back to the user's terminal 105.

The search engine 123 includes a database 309. The database 309 stores data that relates terms to the contents of documents 311 to 315 at various sites 316 and 317 on the World Wide Web 107. Terms are indications of contents of documents that can be used to index a document. In the present embodiment words have their endings removed to form terms, and so terms may be considered as very similar to the words that are actually contained in a document. The database 309 contains details of the relationship between terms and documents. Each term has associated with it a list of documents that contain that term, and additional data. Also stored in the database 309 are the locations of documents. Thus, although document information is stored on the database 309, the documents themselves are not, and a Universal Resource Locator (URL) is stored, thus enabling the document to be retrieved, if it is determined to be likely to be of interest.

The Probabilistic Information Retrieval System 308 comprises a sequence of steps. At a first step 321, the user-selected text 306 is analysed to generate query terms. These query terms are closely related to the user-selected text. At step 322 the query terms generated at step 321 are combined with term data from the database 309 in order to calculate significance values for each of the terms in the query. At step 323, the significance values calculated at step 322 are used in combination with document indexing data from the database 309, in order to calculate a weighting for each document referenced in the database 309. At step 324, documents are ranked on the basis of their weighting calculated at step 323, and at step 325 documents of probable interest are identified to the user in the form of a list of highest ranking documents 307.

Probabilistic Information Retrieval is based on a statistical model of information. Being statistical in nature, documents identified as a result of a query are described as being probably relevant. The level of probability calculated for a document is used to determine the ranking of documents in the results list 307 transmitted back to the user. In its simplest form, a probabilistic information retrieval system uses the rarity of a word as an indication of its significance. Thus, a rare word such as “spectroscopy” is more significant than a common word like “paper”. The probability of a document being relevant is calculated according to the rarity of words that are contained both in the document and in the query.

In the preferred embodiment, it is the notion of word rarity signifying word significance, that fundamentally enables dragging and dropping of user-selected text as a method for defining a query in an information retrieval system.

The search engine 123 may be considered as a searching station and it receives search requests from many selection terminals, such as used in terminal 105. The search engine 123 receives search requests from selection terminals that define many search terms. The probabilistic searching engine 308 identifies terms of high value that occur infrequently in machine readable documents. The station includes procedures and apparatus for generating output data configured to supply the search results data back to the requesting selection terminal.

Each of the selection terminals has apparatus and procedures, that are embodied by the search icon, 307 configured to specify a search. Visual display unit 301 provides a text display means and procedures responsive to operation of mouse 302 provide text selection means allowing a portion of selected text to be conveyed to the search specifying means. The user's computer, with communications apparatus and appropriate procedures, provides output means configured to receive search specifying data from the search specifying means and to transmit a search request to the searching station. The probabilistic search is performed at the searching station and input means at the selection terminal are configured to received the search results from the searching station and to supply the search results to the text display means.

In response to normal operations performed by a user, text will be displayed on monitor 301. This text may have been derived from a web-site, and e-mail or any other form of textural matter. In accordance with conventional windows protocols, a selection of text is made by a highlighting operation, whereafter the highlighted text may be dragged, by operation of the mouse, and dropped on the search icon 307.

The search specifying procedures behind this icon generates a request to the searching station to perform a probabilistic searching operation upon the textural elements provided, perceived by the searching operation as search terms. The probabilistic procedures ensure that priority is given to high value terms, i.e. those terms that occur infrequently within the volume of data that has been considered. In this way, significant technical advantage is provided by the searching operation itself so as to reduce the effort required on the part of the operator in terms of specifying pertinent terms. The operator is not required to analyse the data mentally and select pertinent terms, as would be the case with conventional searching system. The operator merely highlights a volume of text which is considered to be of interest. The searching processes at the searching station are then capable of identifying the terms of high value and then deploying these terms to locate documents of interest.

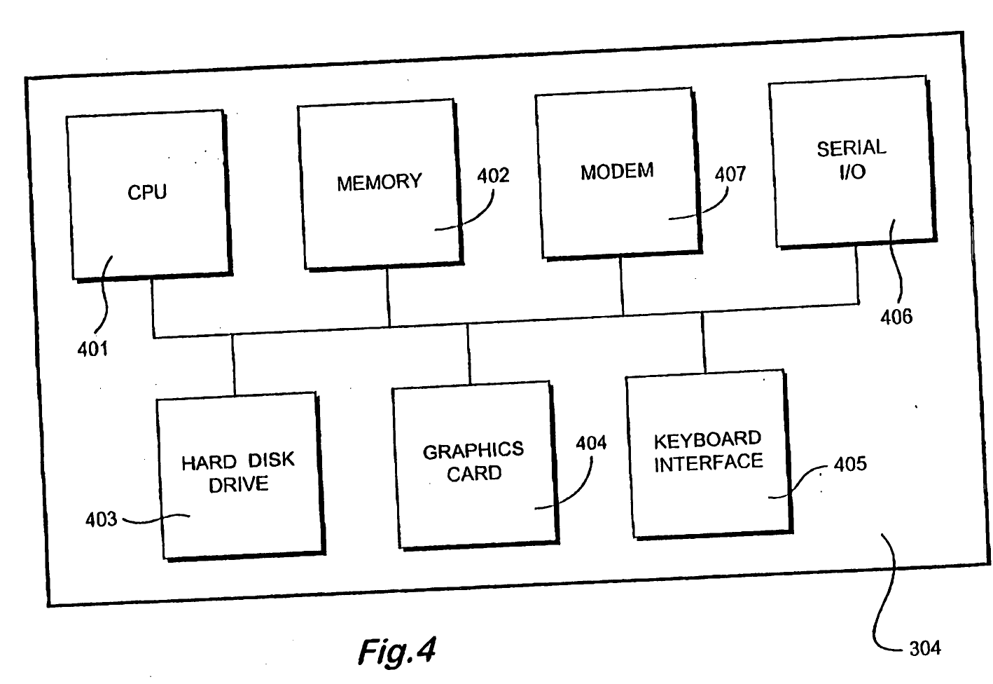

The user's computer 304 shown in FIG. 3 is detailed in FIG. 4. The computer is a standard PC comprising a central processing unit (CPU) 401, such as a Pentium II or equivalent processor. This is connected via data and address connections to memory 402, comprising sixty-four megabytes of dynamic RAM. A hard disk drive 403 provides non-volatile high capacity storage for programs and data. A graphics card 404 receives commands from the CPU 401 resulting in the update and refresh of images displayed on the monitor 301. A keyboard interface 405 provides connectivity to the user's keyboard 303, and a serial I/O circuit 406 receives data from the user's mouse 302. A modem 407 provides electrical connectivity to intranet 102, which provides access to the Internet 107 via the Internet service provider 101.

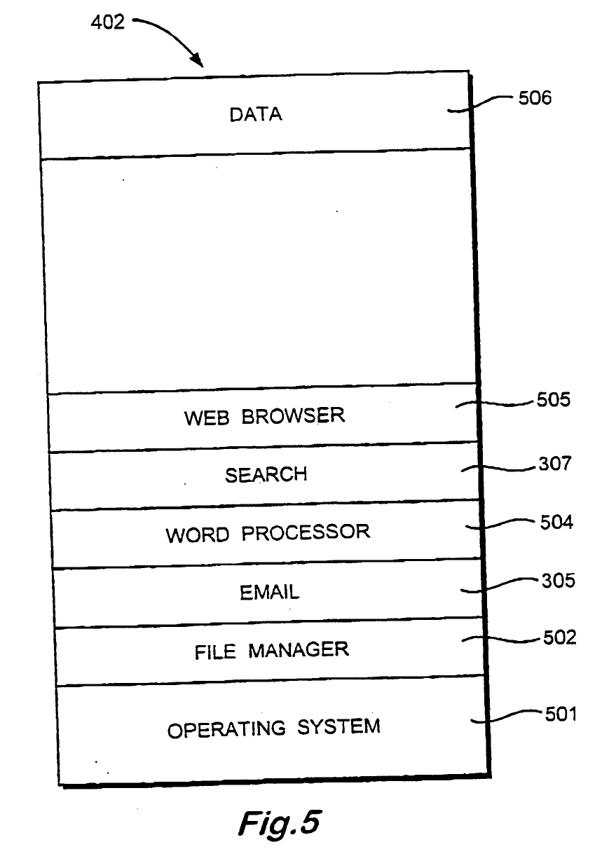

The contents of the computer's memory 402 shown in FIG. 4 are detailed in FIG. 5. An operating system 501 provides instructions for common functionality, such as connection to networks, a graphical user environment and so on. A suitable operating system is Windows 98. In addition to the operating system are application instructions for a file manager 502, the email application 305 shown in FIG. 3, a word processor 504, the search application 307 and a web browser 505. The remainder of the computer's memory 402 is either empty or used for data 506, such as disk data has been cached, or data associated with the applications and or operating system 501.

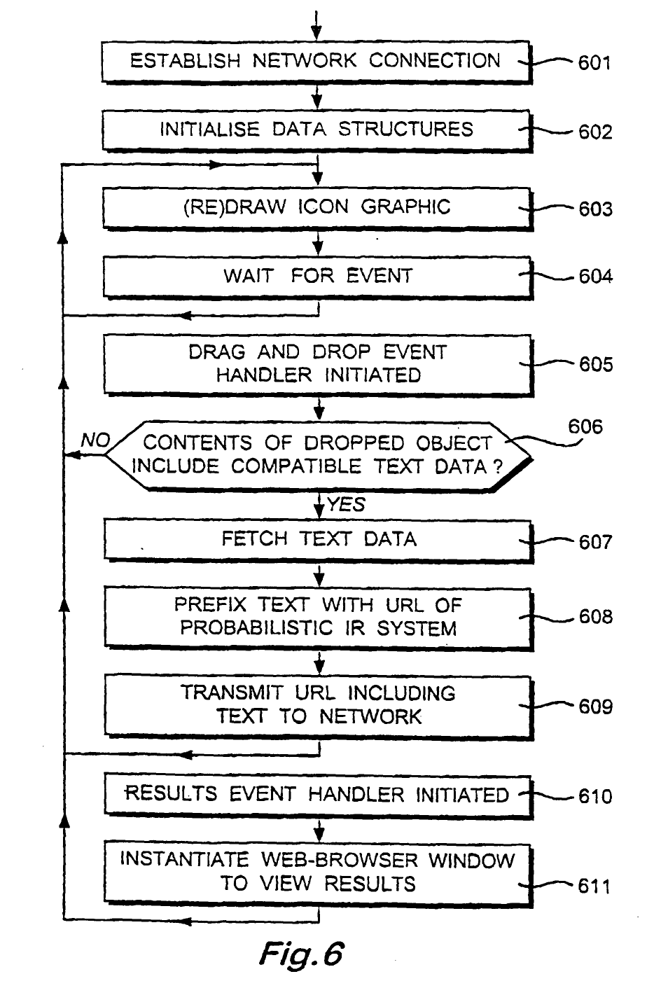

The actions performed by the computer 304 in response to instructions for the search application 307 are detailed in FIG. 6. At step 601 a network connection is established and at step 602 data structures for the search application are established. At step 603 operating system instructions 501 are invoked to draw the search icon 307 on the monitor 301. Commands are supplied from the CPU 401 to the graphics card 404 in order to update the monitor's image. At step 604 the search application 307 ceases processing, and waits for an event from the operating system 501. After any event, step 604 proceeds to step 603, where the icon for the search application 307 is redrawn if necessary.

The first type of event that is recognised by main instructions in the search application 307 is a drag and drop event. When data dropped onto the application icon a drag and drop event handler process is started at step 605. At step 606, a question is asked as to whether the data being dropped is compatible text data. If not, control is directed to step 603 and the drop event is rejected. Alternatively control is passed to step 607, and the user-selected text 306 is fetched from the email application. At step 608 the user-selected text 306 is prefixed by a universal resource locator (URL) for the search engine 123. At step 609 the URL, along with the user-selected text 306, is transmitted over the Internet 107 to the search engine 123. Thereafter, control is directed to step 603, and at step 604 the search application waits for further events.

A final type of event handled by the search application instructions is the event that occurs when a result is received from the search engine. When results are received, a results event handler is initiated at step 610, and at step 611 a web browser window is instantiated in which a list of documents identified by the search engine is displayed.

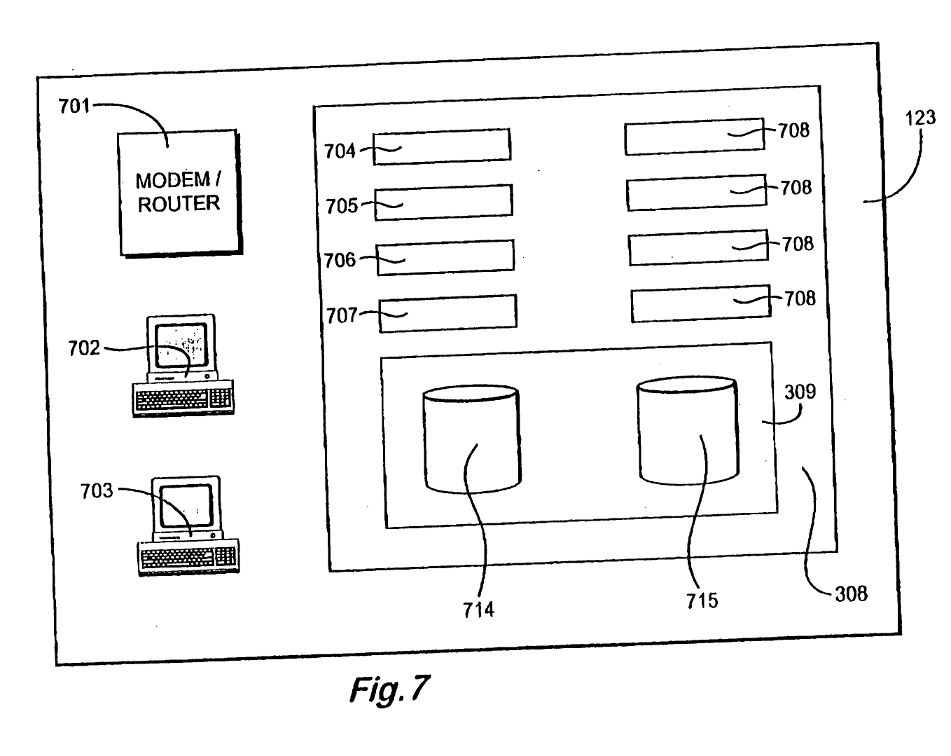

The search engine 123 shown in FIG. 1 is detailed in FIG. 7. A modem and router apparatus 701 facilitates connectivity between the Internet 107 and the various components of the search engine 123. These include two terminals 702 and 703 for controlling and configuring the search engine. The Probabilistic IR System 308 comprises a cluster of network-connected computers 705 to 711. Depending on the anticipated number of users requiring simultaneous access to the search engine, the number of computers 705 to 711 in the cluster may be increased or decreased. The search engine database 309 comprises an array of high capacity hard disk drives 714 and 715, the number of which be increased to satisfy storage requirements.

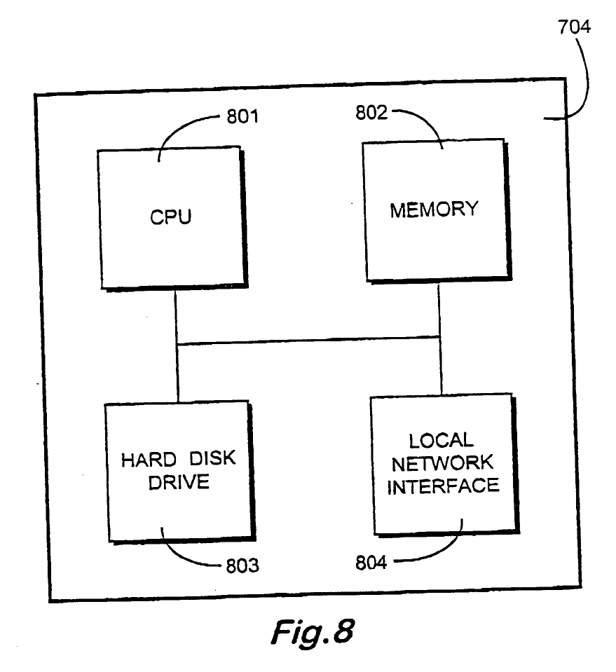

A computer 704 of the type used in the cluster shown in FIG. 7 is detailed in FIG. 8. A Pentium III central processing unit 801 processes instructions and communicates with two hundred and fifty-six megabytes of dynamic RAM 802. A hard disk drive 803 includes non-volatile storage for instructions and data. A local network interface 804 facilitates communication with the modem and router 701, and the two terminals 702 and 703.

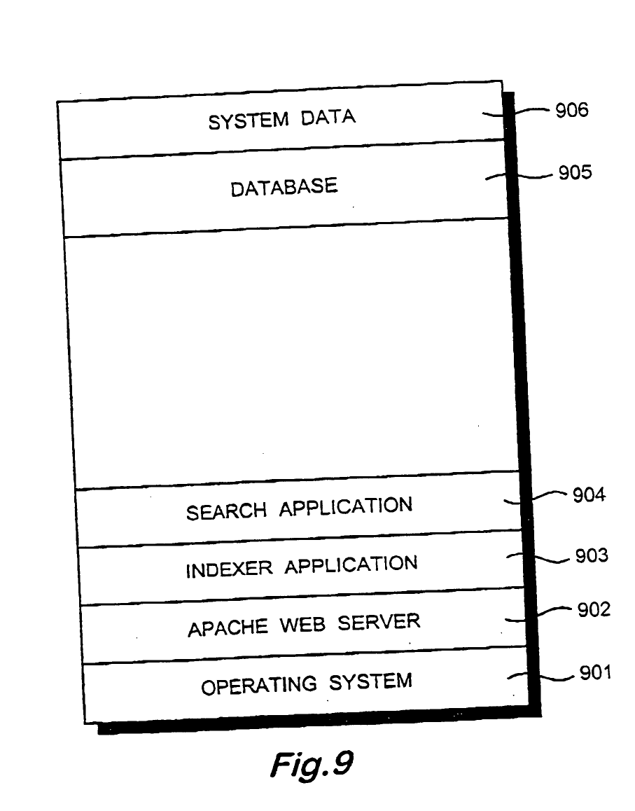

The contents of the memory 802 shown in FIG. 8 are detailed in FIG. 9. An operating system 901 provides common system instructions for the computer, such as disk file system access, network communications and process and memory management. A suitable operating system is the Linux operating system. An Apache web server application 902 supplies web pages on demand from remote Internet users who are connected to the computer 704 via the router 701. The web server application also interacts with other applications, in order to update web pages interactively with remotely-connected users. An indexer application has the function of exploring the world wide web, identifying new documents, storing information about new documents on the search engine's database 309. The indexer application 903 constructs and maintains the large volume of search engine data that will be interrogated whenever user-selected text 306 is supplied to the search engine 123 as a query. A search application 904 comprises the instructions that are executed whenever user-selected text is received from as user in the form of a query. A database 905 includes structured data relating to documents found by the indexer application 903 on the world wide web. It will be appreciated that the volume of data required to represent all indexed documents is enormous, and this will be stored in dedicated high-capacity hard disk storage 714 and 715. The database 905 contains indexing data to facilitate fast access to commonly required search engine data. System data 906 includes configuration and other data for the operating system 901 and applications 902, 903 and 904.

The indexer application 903 runs as a background task on the computer 704. In fact, only one or a few of the computers 704 to 711 in the cluster may be actively engaged in indexing, once the main search engine database 309 has been established. Also, it is possible that computers in the cluster may be separately assigned to indexing and searching. A generic computer, configured to run both processes, is used in this example.

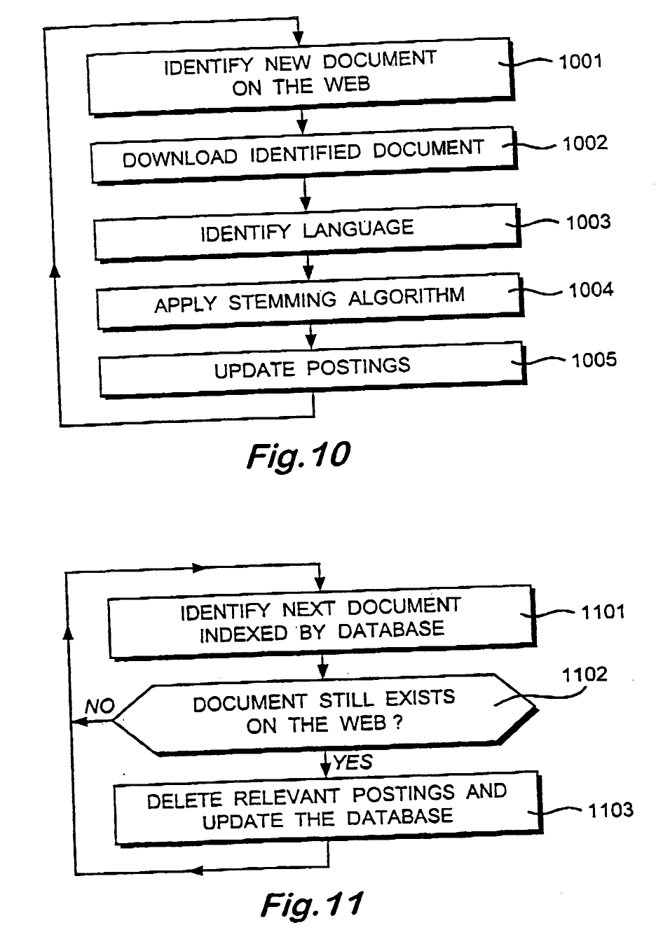

The steps performed by the indexer application 902 shown in FIG. 9 are detailed in FIG. 10. At step 1001 a new document is identified on the world wide web. At step 1002, the new document is downloaded for further processing. At step 1003 the language of the document, such as French, German or English, is identified. This identification is required for step 1004, where a stemming algorithm, appropriate to the language of the document, is applied. At step 1005 postings are updated on the search engine database 309. Substantially in parallel with operations carried out in FIG. 10, the indexer may additionally perform the steps shown in FIG. 11. These steps select each web document listed in the database 309, and check to see if it is still accessible on the web. At step 1101 the next document indexed by the database is selected. At step 1102 a question is asked as to whether the document still exists on the web. If answered in the affirmative, control is directed to step 1101. Alternatively, if the document is no longer available, control is directed to step 1103. At step 1103, postings relevant to the document are deleted and the database 309 is updated. Thereafter, control is directed to step 1101.

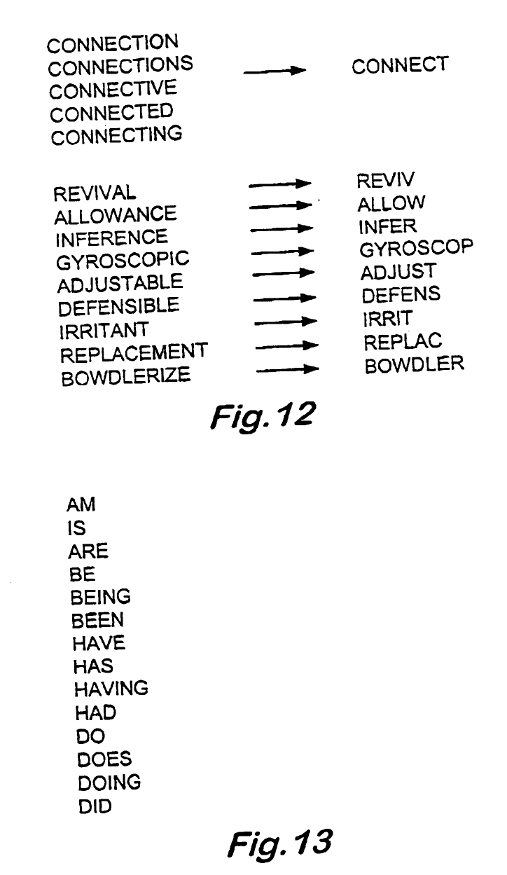

A stemming algorithm takes as its premise the idea that words having identical first portions but different endings, nevertheless have similar meanings. This is true of many Indo-European languages. FIG. 12 shows examples of the effects of a stemming algorithm for the English language. The five variants of the word “connection” are stemmed to “connect”. It is not necessary for the stemmed version to be a correct English word. This is shown in the remaining examples in FIG. 12, such as “revival”→“reviv”, and so on. A suitable stemming algorithm for the English language is the Porter Stemming Algorithm, described in “An algorithm for suffix stripping” by M. F. Porter, published in Program, 14 no.3, pp 130-137, July 1980, presently available at http: //open.muscat.co.uk/developer/docs/porterstem.html. Stemming algorithms have been developed for languages other than English and are also available from this site.

The stemming algorithm is applied to the document data at step 1004, thus translating all the words it contains into a stemmed form. In addition to stemming, the algorithm may stop certain extremely common words that contain little meaning. A selection of stop words is shown in FIG. 13. The stemmed form of the document ensures that similar words with similar meanings are considered, as far as the probabilistic retrieval system is concerned, identical. The stemming algorithm introduces a degree of natural language understanding into the system with very little computational overhead.

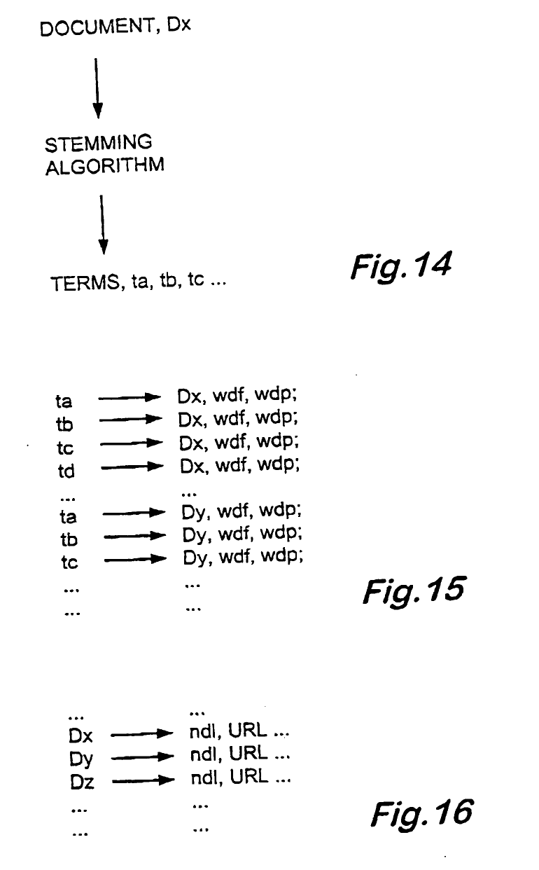

The context of the stemming algorithm applied at step 1004 is summarised in FIG. 14. A document, Dx, is supplied to the stemming algorithm, and this results in words being stemmed, or occasionally stopped. A list of unique words is generated. Each unique word considered a term, and each term, ta, tb and tc, has associated with it a within document frequency (wdf), and within document position (wdp) data comprising a list of word positions in the originating document where the term occurs. For example, if the word “relativity” occurs at word positions five and fifty in the original document, the term “relativ” will have an associated wdf of two, and wdp data values of five and fifty.

The search engine's database 309 includes a set of postings, each of which comprises a link between a term and a document. A short set of postings is illustrated in FIG. 15. In this Figure, term ta is posted to document Dx. Along with this posting are the wdf and wdp data. Term tb also has a posting to document Dx, and this posting has its own unique wdf and wdp data.

When a new document is analysed into terms, postings such as those illustrated in FIG. 15 are updated on the search engine database 309. They contain the essential data about a document that is needed in order to facilitate document retrieval. Rather than storing the entire original document in the database, a pointer incorporating the document's URL is used. The database 309 itself is implemented in a highly optimised manner, so that the incredibly large number of documents it references does not result in impossible storage requirements. Implementation of a database of this type is known in the art of web server technology.

In addition to the postings shown in FIG. 15, the database 309 includes normalised document length (ndl) data associated with each document, and a URL containing the address of the document on the world wide web. An example of these is shown in FIG. 16. The normalised document length is calculated as being the ratio of the document's length in words, divided by the average length of all documents that are accessible via the database 309. Thus small documents have a value less than one, large documents greater than one, and an average length document an ndl of exactly one. The data structures illustrated in FIG. 15 and FIG. 16 are suitable for implementation as individual tables within a relational database structure that is used for the search engine database 309. Indexing and hashing techniques can then be used, in conjunction with a local database 905 in an individual computer 705, in order to ensure highly efficient access to the large amounts of data that are being stored, updated and accessed by this system.

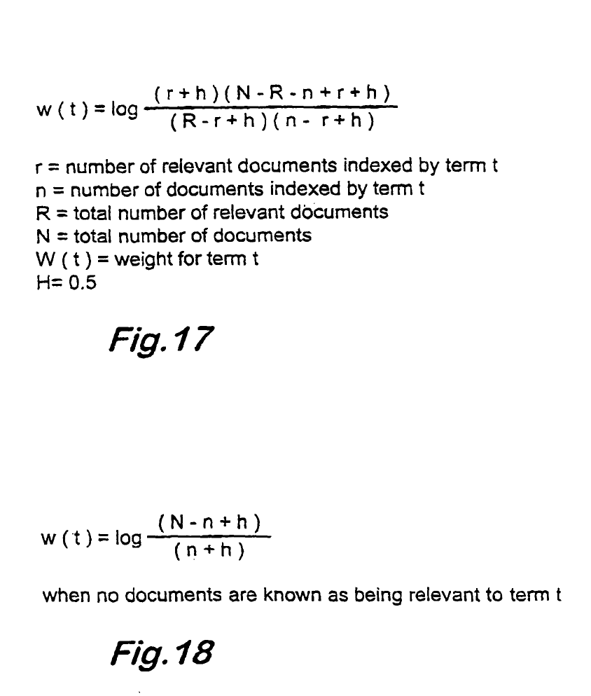

In probabilistic data retrieval, each unique word, or term, is assigned a weight, w(t), in accordance with its rarity in the document set as a whole. A term is said to index a document when the document contains that term. Thus, all documents containing words that stem to “relativ” are considered as being indexed by the term “relativ”. In an ideal probabilistic data retrieval system, documents will have been determined as being relevant to a term. So, for example, a skilled librarian may have been employed to determine which documents are relevant to a term. This may or may not directly correspond with a term's indexing data. For example, the term “relativ” may be considered as being relevant to a document about Riemann Space, even though this document does not contain any words that stem to “relativ”. When relevance data of this kind is known, in addition to the indexing of terms to documents, an equation shown in FIG. 17 may be used to determine an overall weight to each unique term that is used in the database 309. This equation is based upon a theoretical model of probabilistic information retrieval, and has been found to generate significance weightings for terms that result in optimal performance of a probabilistic information retrieval system. Values for w(t) will be required whenever a user supplies user-selected text as part of a search.

Although indexability of documents by terms can be determined relatively easily for documents found on the world wide web, relevance requires knowledge about document contents beyond that which is easily obtainable in an automatic information retrieval system of this type. When no documents are known as being relevant to a term t, the equation for w(t) shown in FIG. 17 simplifies to the one shown in FIG. 18. By examining the behaviour of this equation for different values of n and N, the weighting w(t) can be seen to increase with the rarity of documents indexed by term t. This is the mathematically precise formulation of the concept of significance weighting, that enables the dragging and dropping of text to be used as a useful method for defining a query for a search engine. A summary of equations used in probabilistic information retrieval is given in “Simple Proven Approaches to Text Retrieval”, by S. E Robertson and K. Sparck Jones, Technical Report No. 356, University of Cambridge Computer Laboratory, Cambridge CB2 3QG, England 1994.

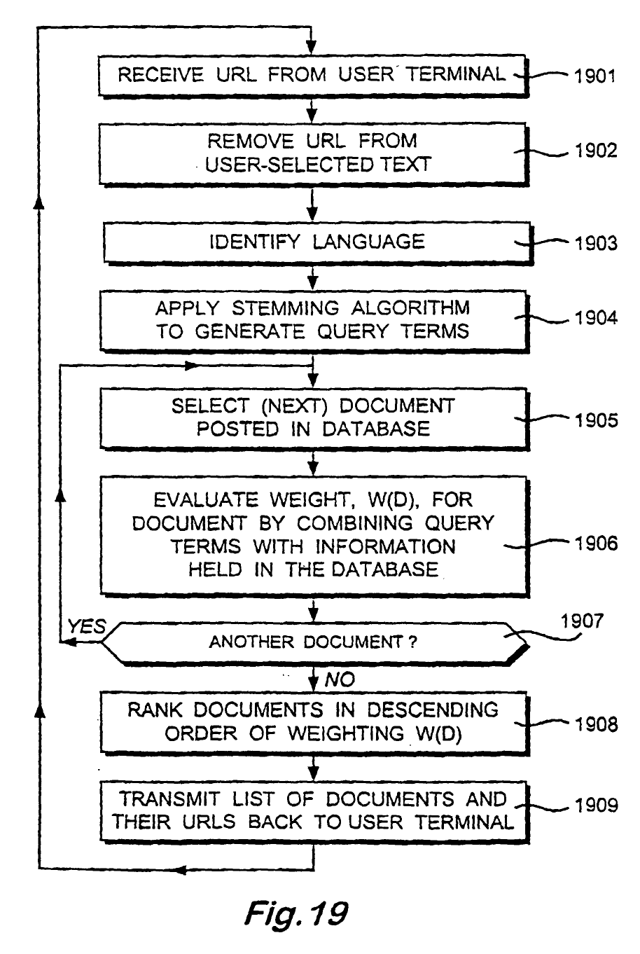

The steps performed by the search application 904 running on the computer 704 in the search engine 123 are detailed in FIG. 19. At step 1901 a URL is received from the user terminal 105 via the Internet 107 and the modem/router 701. At step 1902 the URL prefix is removed from the URL, leaving just the user-selected text 306. At step 1903 the language of the query is identified. This can be performed by comparing words in the query with a vocabulary, or by using contextual information, such as the country from which the search data was supplied, or by making the assumption that the query is in English. At step 1904 a stemming algorithm is applied to the user-selected text, in the manner described for step 1004 in FIG. 10. This results in the generation of a set of query terms. Within query frequency (wqf) and within query position (wqp) data is stored in association with each term that is generated by the stemming algorithm from the user-selected text 306. Steps 1905 to 1907 may be implemented in a more efficient form than that which is about to be described. This will be apparent to those skilled in the art of database access. However, for the benefit of clarity of the desired effect, the present explanation is used. At step 1905 the first document in the database 309 is selected. At step 1906 the weight W(D) for the document is evaluated by combining query term data and document data. These data may include wdf, wdp, wqf and wqp data previously described. At step 1907 a question is asked as to whether another document is available for consideration. If so, control is directed back to step 1905, and W(D) for the next document is calculated at step 1906. Alternatively, when all documents have been considered, control is directed to step 1908, where the documents are ranked in descending order of their W(D) values calculated at step 1906. At step 1909 a list comprising several of the top ranking documents is transmitted over the Internet back to the user at terminal 105. Thereafter, control is directed to step 1901, where the search process awaits another user query.

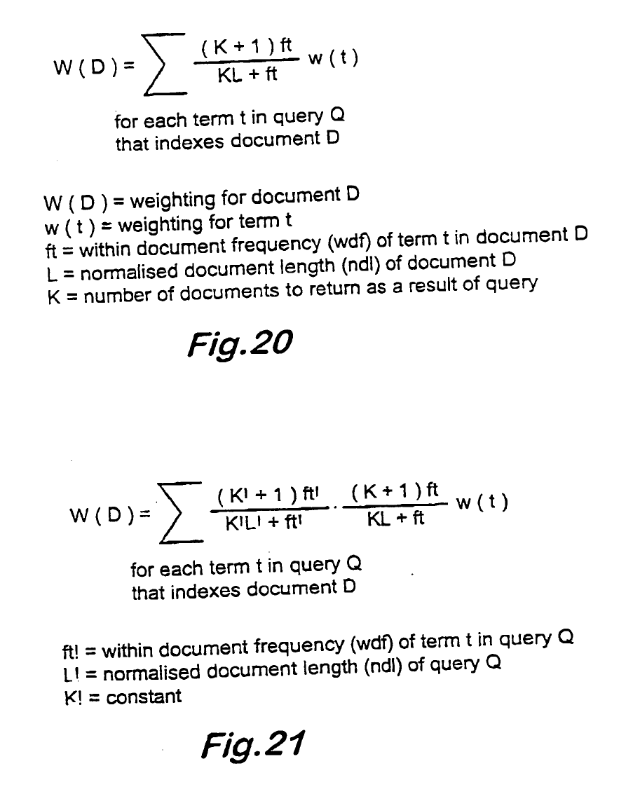

An equation for calculating the weight W(D) of a document D is shown in FIG. 20. This equation includes a value for w(t) for each term generated from the user-selected text 306. These values for w(t) are calculated in accordance with the equation shown in FIG. 17 or FIG. 18, using data gathered during the process of indexing documents on the web. For long queries of several hundred characters, some words may be repeated, and within query frequency (wqf) and normalised document length (ndl) of the query can be taken into account in order to improve the accuracy to which the probability of a document's relevance can be determined. An equation including wqf and wdl for the query, is shown in FIG. 21.

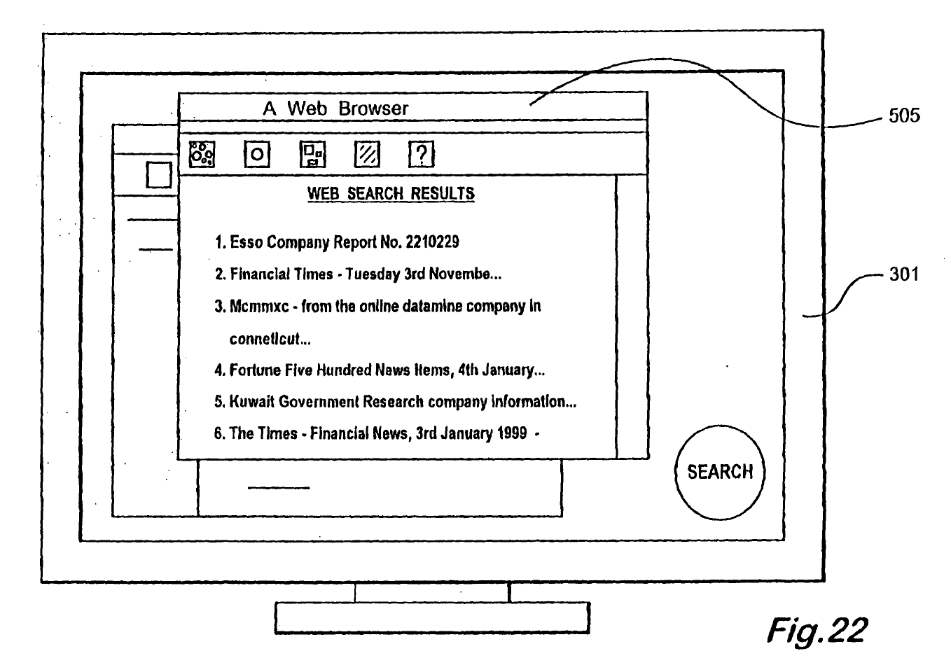

The result of actions performed by the search engine 123 at step 1909, in conjunction with actions performed by the user's computer 304 at step 611, are illustrated in FIG. 22. The user's monitor 301 includes a window generated by the web browser application 505. The list of documents 307 has been received by the user's computer 304 and displayed.

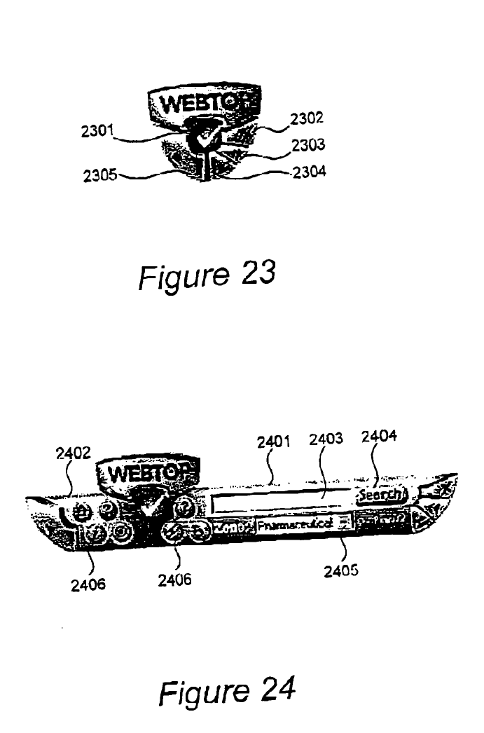

The search icon 307 is detailed in FIG. 23. To perform a search based on text identified as a drag and drop operation, the highlighted text is dropped into region 2301. Usually, the icon is continually displayed on top of all underlying windows and may be instantiated during start up. The window may be closed by operation of button 2302 or minimised by operation of button 2303. Operation of button 2304 results in a right hand extension extending from the icon whereas operation of similar button 2305 results in a left hand extension extending from the icon.

Right hand extension 2401 and left hand extension 2402 are shown in FIG. 24. A search box 2403 allows text to be typed into the icon as an alternative to performing a drag and drop operation. After text has been typed into box 2403 operation of search button 2404 results in the data being transmitted to the searching station so as to perform a search and to return information back. A drop down selector 2405 allows particular zones of interest to be identified and buttons 2406 may be programmed to provide additional functionalities, such as the provision of help pages, the selection of additional searching activities or the definition of preferences and settings.

Overall, the system provides a mechanism for allowing a sophisticated searching operation to be effected in response to a relatively straight forward user operation.

1. Searching apparatus having a searching station and a plurality of selection terminals, said searching station comprising
search request receiving means configured to receive search requests from said selection terminals in the form of a plurality of search terms;
probabilistic searching means configured to identify terms of high value that occur infrequently in machine readable documents; and
output data generating means configured to supply search results data to a requesting selection terminal: each of said selection terminals comprising
search specifying means;
text display means;
text selection means configured to respond to manual input commands so as to convey a portion of selected text to said search specifying means; and
output means configured to receive search specifying data from said search specifying means and to transmit a search request to said searching station; and
input means configured to receive search results from said searching station and to supply said search results to said text display means.

2. Apparatus according to claim 1, wherein said probabilistic searching means is configured to analyse user selected text to identify query terms.

3. Apparatus according to claim 2, wherein said probabilistic searching means is configured to calculate a significance value for each of said identified terms, wherein said significance value is inversely related to the frequency of occurrence.

4. Searching apparatus according to claim 1, wherein probabilistic searching means is configured to calculate a weighting value for each document referenced in a database by combining significance values of each query term that indexes that document.

5. Apparatus according to claim 4, wherein probabilistic searching means is configured to compare weighting values so as to rank weighted documents.

6. Apparatus according to claim 5, wherein said probabilistic searching means is configured to identify documents of interest in response to said ranking.

7. Searching apparatus according to claim 1, wherein said searching station and said selection terminals communicate over the internet.

8. Searching apparatus according to claim 1, wherein said search results define world-wide web locations.

9. Searching apparatus according to claim 1, wherein said search specifying means is configured to display an icon on said text display means.

10. Searching apparatus according to claim 9, wherein selected portions of text are conveyed to said search specifying means as a drag and drop operation.

11. A method of searching at a searching station, comprising the steps of:
receiving search requests from one of a plurality of selection terminals defined by a plurality of words copied from text displayed at said requesting selection terminal;
performing a probabilistic search using high value terms derived from said received words from which high value terms occur infrequently within source material referenced by an indexed database; and
supplying search results to said requesting selection terminal.

12. A method according to claim 11, wherein said probabilistic search calculates the weighting value for each document referenced in the database by combining significance values of each query term that indexes that document.

13. A method according to claim 12, wherein said probabilistic search compares weighting values so as to rank weighted documents.

14. A method according to claim 13, wherein said probabilistic search identifies documents of interest in response to said ranking.

15. A method of instructing a probabilistic searching station to perform a search for locations of interest in which high value indexed terms are stored in a database, being terms that occur infrequently in source material locatable over the internet, comprising the steps of
instantiating a search tool icon having the location of said searching station embedded therein and configured to convey search terms to said location;
displaying textural matter;
identifying a region of said displayed matter as being matter of interest;
conveying a representation of said matter of interest to said displayed icon; and
displaying data received from said searching station.

16. A method according to claim 15, wherein said display data identifies world-wide web locations.

17. A computer readable medium having computer readable instructions executable by a computer such that, when executing said instructions, a computer will perform the steps of:
receiving search requests from one of a plurality of selection terminals defined by a plurality of words copied from text displayed at said requesting terminal;
performing a probabilistic search using high value terms derived from said received words from which high value terms occur infrequently within source material referenced by an indexed database;
supplying search results to said requesting selection terminal.

18. A computer readable medium having computer readable instructions according to claim 17, such that when executing said instructions said probabilistic search will calculate a weighting value for each document referenced in a database by combining significance values of each query term that indexes that document.

19. A computer readable medium having computer readable instructions according to claim 18, such that when executing said instructions a computer will also perform the step of comparing weighting values so as to rank weighted documents.

20. A computer readable medium having computer readable instructions executable by a computer such that, when executing said instructions a computer will perform the steps of:
instantiating a search tool icon having the location of a searching station embedded therein and configured to convey search terms to said location, wherein said searching station performs a probabilistic search for locations of interest in which high value indexed terms are stored in a database, being terms that occur infrequently in source material locatable over the internet;
displaying textural matter;
responding to manual intervention to identify a region of said displayed matter as being matter of interest;
responding to manual intervention in order to convey a representation of said matter of interest to said display icon; and
displaying data received from said searching station.
